(19) United States
(12) Patent Application Publication
(10) Pub. No.: US 2023/0380407 A1
(43) Pub. Date: Nov. 30, 2023

(54) BIRD DETERRANCE SYSTEM

(71) Applicant: 1323515 B.C. LTD., Westbank (CA)

(72) Inventor: Shayne Tulloch, Westbank (CA)

(21) Appl. No.: 18/323,635

(22) Filed: May 25, 2023

Related U.S. Application Data
(60) Provisional application No. 63/345,827, filed on May 25, 2022.

(51) Int. Cl. A01M 29/08

(52) U.S. Cl. CPC A01M 29/08

(57) ABSTRACT

A system and method for deterring animals from entering a protected region. The system comprises an elongate flexible member extending between first and second ends and a plurality of flexible elongate hanging members secured to and suspended from the elongate flexible member. The method comprises extending the elongate flexible member across the protected region and securing the ends of the elongate flexible member to an anchor so as to suspend the elongate flexible member above the protected region.

### RELATED APPLICATION

This application claims priority to U.S. Provisional Application No. 63/345,827 filed on May 25, 2022, which is hereby incorporated by reference herein in their entirety.

It is intended that the above-referenced application may be applicable to the concepts and embodiments disclosed herein, even if such concepts and embodiments are disclosed in the referenced applications with different limitations and configurations and described using different examples and terminology.

### BACKGROUND OF THE DISCLOSURE

This disclosure relates generally to facilities management and in particular to a system and method of deterring birds and other animals from entering into a region.

Birds and other animals are a known hazard to a variety of industries. In one instance, some industries require hazardous materials to be stored in an open surface pond for settling or dissipation of toxic or otherwise harmful components. Such settling ponds, can be quite large and include substances which may be toxic or otherwise harmful. In such environments, it is desirable to prevent birds and other animals from landing in the pond where they may be subjected to or injured by such substances.

Previous attempts to prevent birds from landing on such hazardous locations have not been satisfactory. In particular, some solutions have attempted to extend wires across the body of water so as to prevent birds passing through. However, such wires are relatively heavy when extending over a large body of water, thereby requiring substantial equipment for the installation and maintenance thereof. Furthermore, such wires provide only a limited visual deterrence to birds which may therefore inadvertently fly into the wires causing them to fall into the water. Examples of such systems may be found in U.S. Pat. No. 5,845,607 to Kastner et al.

Other systems have been proposed to provide a largely visual deterrence through the use of movable tow lines having deterrent devices suspended therefrom. In such systems however, include large motor assemblies which may be difficult and expensive to install and maintain.

### BRIEF OVERVIEW OF THE DISCLOSURE

According to a first embodiment, there is disclosed a system for deterring animals from entering a protected region comprising an elongate flexible member extending between first and second ends and a plurality of flexible elongate hanging members secured to and suspended from the elongate flexible member.

The system may further comprise anchors secured to a surface to either side of the protected region. The anchors may comprise posts. The system may further comprise a tensioning adjustor extending from at least one of the posts to the elongate flexible member.

The elongate flexible member may be formed of a strap material selected from the group consisting of a weave or webbing. The strap material may be substantially inelastic. The strap material may be selected form the group consisting of nylon, polyester polypropylene, nylon, plastics or fabrics. The hanging members may be selected form the group consisting of nylon, polyester polypropylene, nylon, plastics or fabrics.

The hanging members may be formed of strap material selected from the group consisting of a weave or a webbing. The hanging members may have a different color than the elongate flexible material. The hanging members may include a bright or reflective portion. The reflective portion may comprise strips along the length of the hanging members. The reflective portion may comprise a strip proximate to each of a first and second edge of the hanging member.

The hanging members may be spaced along the elongate flexible material at regular intervals. The hanging member may be secured to the elongate flexible material by stitching.

According to a further embodiment, there is disclosed a method of deterring animals from entering a protected region comprising providing an elongate flexible member with a plurality of hanging members therefrom, extending the elongate flexible member across the protected region and securing the ends of the elongate flexible member to an anchor so as to suspend the elongate flexible member above the protected region.

Other aspects and features of the present disclosure will become apparent to those ordinarily skilled in the art upon review of the following description of specific embodiments in conjunction with the accompanying figures.

### BRIEF DESCRIPTION OF THE DRAWINGS

The accompanying drawings constitute part of the disclosure. Each drawing illustrates exemplary aspects wherein similar characters of reference denote corresponding parts in each view.

FIG. 1 is a perspective view of a system for deterring animals from entering a space located across a body of water according to a first embodiment of the present disclosure;

FIG. 2 is a detailed perspective view of one of the hanging members of the system of FIG. 1;

FIG. 3 is a detailed perspective view of one of the hanging members of the system of FIG. 1 according to a further embodiment; and

FIG. 4 is a perspective view of a storage and transportation vessel for use with the system of FIG. 1 according to a further embodiment.

### DETAILED DESCRIPTION OF THE DISCLOSURE

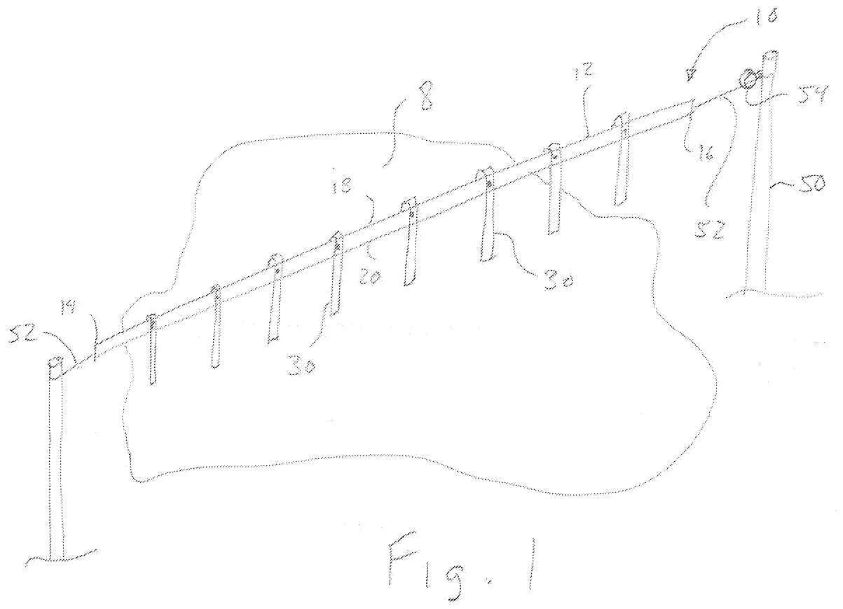

Aspects of the present disclosure are now described with reference to exemplary apparatuses, methods and systems. Referring to FIG. 1, an exemplary apparatus for deterring animals from a protected region 8 according to a first embodiment is shown generally at 10. Although the below description describes for use in preventing birds from entering a region, it will be appreciated that it may be useful for preventing entry of other animals as well. The system comprises an elongate flexible member 12 extending between first and second ends and a plurality of flexible elongate hanging members 30 secured thereto and is adapted to be suspended over the protected region so as to provide a visual and physical deterrent to birds passing therethrough and landing in the protected region.

The elongate flexible member 12 comprises an elongate member extending between first and second ends 14 and 16. As illustrated, the first and second ends 14 and 16 may be connected to a cable 52, ropes or other members so as to permit connection of the elongate flexible member 12 to be secured to an anchor such as a post 50 or the like. The elongate flexible member 12 is formed of a strap or webbing material and has a substantially flat profile between first and second side edges 18 and 20, respectively. The elongate flexible material may be substantially non-elastic and formed in a width and thickness to provide sufficient strength to be suspended and pulled tight over the top of the protected region. In practice, it has been found that a width of between 0.5 and 2.5 inches (12 and 64 mm) has been useful for a nylon strap with a thickness of 1/32 inches (0.9 mm) although it will be appreciated that other sizes may be useful as well. In particular, the elongate flexible member may be formed of a suitable webbing, woven or fabric material including, but not limited to nylon, polyester polypropylene, nylon, plastics or fabrics. It will be appreciated that such fabrics and materials are substantially lighter than cables thereby assisting with the installation of the present system.

The hanging members 30 extend between first and second ends, 32 and 34, respectively and are formed of a suitable woven or fabric material including, but not limited to nylon, polyester polypropylene, nylon, plastics or fabrics. The hanging members 30 have a length and dimensions selected to be movable in a wind or breeze so as to create movement of the hanging members 30 thereby providing a visual indicator to birds. In practice, it has been found that length of between 12 and 48 (305 and 1219 mm) inches for a hanging member, and in particular between 20 and 24 inches (508 and 600 mm) with a width of between 0.5 and 2.5 inches (12 and 64 mm) has been useful for a nylon strap with a thickness of 1/32 inches (0.9 mm) although it will be appreciated that other sizes may be useful as well. Although the hanging members 30 are illustrated as substantially rectangular in shape, it will be appreciated that other outline shapes may be useful as well. The hanging member 30 may be formed of a length of strapping, by way of non-limiting example, by cutting a portion of the web strapping to the desired length and thereafter fusing the ends (generally indicated at 54) so as to prevent fraying or the like by the application of heat or an adhesive as is commonly known.

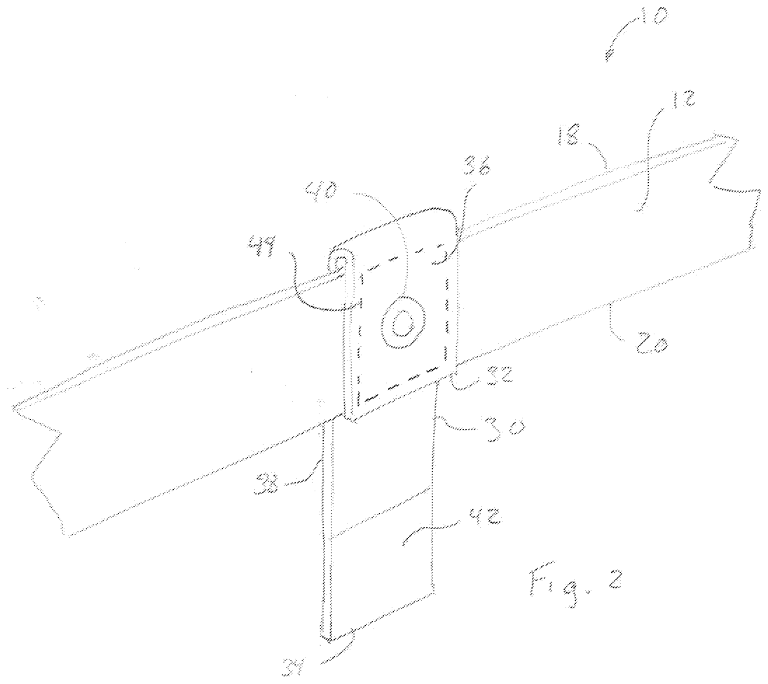

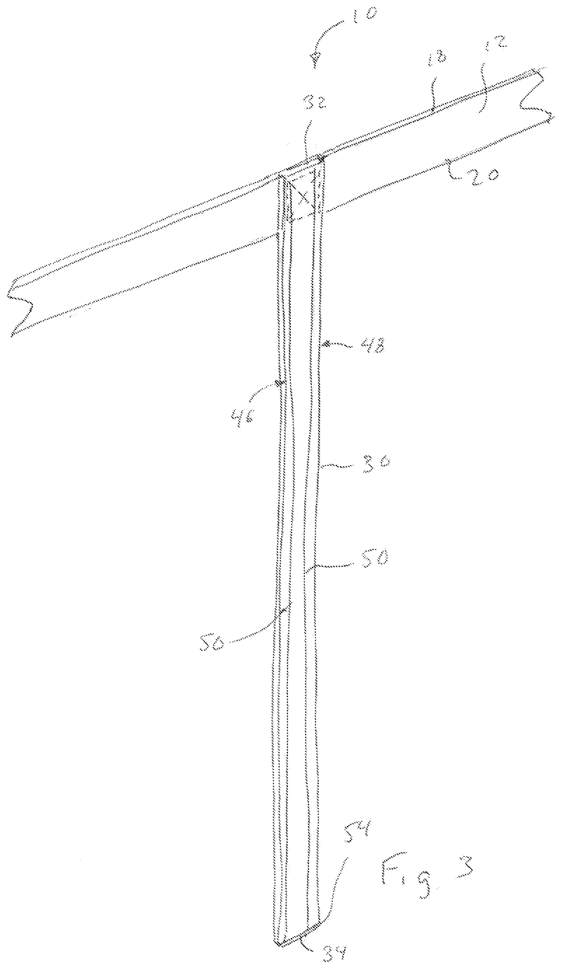

As illustrated in FIG. 2, the hanging member may be suspended over one edge 18 of the elongate flexible member 12 so as to include the first end 32 on one side thereof and the second end 34 on the other side thereof. In such a manner the hanging member includes a first portion 36 on one side proximate to the first end 32 and a second portion 38 on the opposite side of the elongate flexible member. Optionally, the hanging member 30 may be secured to the elongate flexible member 12 at a single side thereof as illustrated in FIG. 3 without extending a portion thereof over the elongate flexible member 12. A fastener 40, such as a rivet, screws and bolts or the like may be passed through the first and second portions 36 and 38 as well as the elongate flexible member 12 so as to secure the hanging member 30 thereto. Optionally other securing means, such as, by way of non-limiting example, stitching 44, adhesives or the like may be utilized. It will be appreciated that any desired or common pattern for such connection method may be utilized. As illustrated in FIGS. 2 and 3, the stitching 44 may be arranged in any pattern or arrangement between the elongate flexible member 12 and the hanging member 30 including, without limitation, box, parallel lines, crosses or any combination thereof.

The hanging member 30 may be formed of a color that is selected to contrast with the elongate flexible member 12, such as, by way of non-limiting example red, orange or yellow against a neutral elongate flexible member. Furthermore, the hanging member may include a reflective portion 42 there along to increase the visual deterrence for birds. As illustrated in FIG. 2, the reflective portion may comprise a portion located proximate to the second end 34 of the hanging member 30. Optionally, the reflective portion may comprise strips 50 of reflective material extending along the length of the hanging member proximate to first and second side edges, 46 and 48, respectively, of the hanging member 30. The strips 50 may be formed of independent bodies or material adhered or otherwise secured to the hanging member or may optionally comprise one or more strands of reflective threading woven into the webbing material of the hanging member.

As illustrated in FIG. 1, the hanging members 30 may be suspended from the elongate flexible member 12 at regular intervals there along such as, by way of non-limiting example, between 1 and 20 feet (305 and 6096 mm) depending on the installation, and birds that are intended to be deterred. It will be appreciated that although only one elongate flexible material 12 is illustrated in FIG. 1, a plurality of elongate flexible materials may be positioned over a protected region 8 in any desired patter, such as, by way of non-limiting example parallel to each other. As set out above, the system may also include posts 50 or other suitable anchors for supporting and securing the ends of the elongate flexible member 12. Cables 52, or other tensile members may be secured between the posts 50 and the elongate flexible member 12 so as to connect them thereto using any known means, including, without limitation eyelets, clamps, fasteners, adhesives or the like. It will be further appreciated that a winch 54 may also be provided on one end to tension the elongate flexible member 12 to the desired tension. Optionally any other suitable tensioning device, including without limitation, a turnbuckle, rope, ratchet strap or the like.

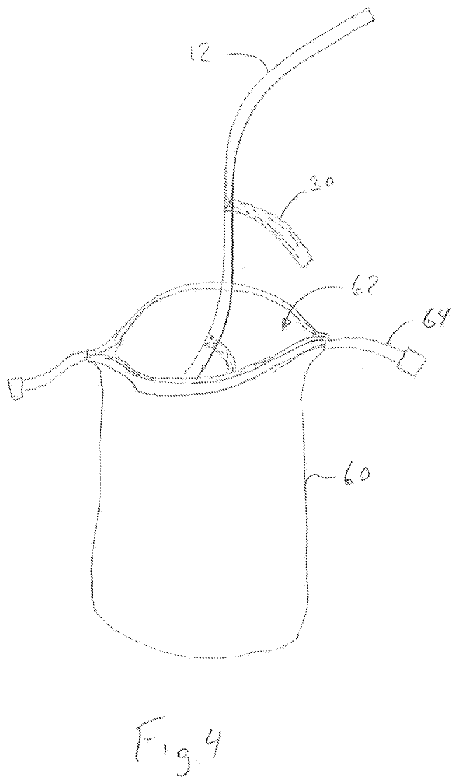

As illustrated in FIG. 4, the elongate flexible member 12 may be stored and transported within a vessel 60 having an open top sized to contain the provided length of the elongate flexible member 12 within an interior 62 thereof. As illustrated, the vessel 60 may comprise a bag or other soft container and may be selectably closable by any suitable means. By way of non-limiting example, as illustrated in FIG. 4, the vessel 60 may comprise a waterproof bag having a roll top closure 64 as are known.

While specific embodiments have been described and illustrated, such embodiments should be considered illustrative only and not as limiting the disclosure as construed in accordance with the accompanying claims.

The following is claimed:

1. A system for deterring animals from entering a protected region comprising:
an elongate flexible member extending between first and second ends; and
a plurality of flexible elongate hanging members secured to and suspended from the elongate flexible member.

2. The system of claim 1 further comprising anchors secured to a surface to either side of the protected region.

3. The system of claim 2 wherein the anchors comprise posts.

4. The system of claim 2 further comprising a tensioning adjustor extending from at least one of the posts to the elongate flexible member.

5. The system of claim 1 wherein the elongate flexible member is formed of a strap material selected from the group consisting of a weave or webbing.

6. The system of claim 5 wherein the strap material is substantially inelastic.

7. The system of claim 5 wherein the strap material is selected form the group consisting of nylon, polyester polypropylene, nylon, plastics or fabrics.

8. The system of claim 1 wherein the hanging members is selected form the group consisting of nylon, polyester polypropylene, nylon, plastics or fabrics.

9. The system of claim 8 wherein the hanging members are formed of strap material selected from the group consisting of a weave or a webbing.

10. The system of claim 8 wherein the hanging members have a different color than the elongate flexible material.

11. The system of claim 8 wherein the hanging members includes a bright or reflective portion.

12. The system of claim 11 wherein the reflective portion comprise strips along the length of the hanging members.

13. The system of claim 12 wherein the reflective portion comprises a strip proximate to each of a first and second edge of the hanging member.

14. The system of claim 1 wherein the hanging members are spaced along the elongate flexible material at regular intervals.

15. The system of claim 14 wherein the hanging member are secured to the elongate flexible material by stitching.

16. A method of deterring animals from entering a protected region comprising:
providing an elongate flexible member with a plurality of hanging members therefrom;
extending the elongate flexible member across the protected region; and
securing the ends of the elongate flexible member to an anchor so as to suspend the elongate flexible member above the protected region.
